(19) United States
(12) Patent Application Publication
(10) Pub. No.: US 2017/0169785 A1
(43) Pub. Date: Jun. 15, 2017

(54) SCAN DRIVING METHOD FOR DISPLAY PANEL

(71) Applicant: SHENZHEN CHINA STAR OPTOELECTRONICS TECHNOLOGY CO., LTD., Shenzhen (CN)

(72) Inventor: Xiaoxiao WANG, Shenzhen (CN)

(21) Appl. No.: 14/906,557

(22) PCT Filed: Jan. 6, 2016
(86) PCT No.: PCT/CN2016/070286

§ 371 Date: Jan. 21, 2016

(30) Foreign Application Priority Data
Dec. 10, 2015 (CN) 201510918803.X

(51) Int. Cl. G09G 3/36; G02F 1/1345; G02F 1/1362

(52) U.S. Cl. CPC G09G 3/3677; G09G 3/3688; G02F 1/136286; G02F 1/13454; G09G 2310/0202; G02F 1/1368

(57) ABSTRACT

A scan driving method for a display panel is disclosed. The display panel has a pixel driving circuit including n scanning lines and m data lines; and the scanning lines and the data lines intersect each other to define a plurality of pixel units. The scan driving method includes a step of enabling the xth scanning line by a clock signal having a duty cycle not more than 45%, and meanwhile enabling the (x+2)th scanning line, where x is an positive integer and 1≦x≦n−2.

### BACKGROUND OF THE INVENTION

Field of the Invention

The present invention relates to the field of liquid crystal display, and more particularly to a scan driving method for a display panel.

Description of the Related Art

At present, in the industry of liquid crystal displays, the key to maintain the competitive advantages of liquid crystal display panel enterprises is to reduce the cost and improve the quality. Secondly, in order to meet market demands, the resolution and the transmittance of large-size display panels are required to be enhanced, which will shorten the time for enabling each scanning line and thereby inevitably resulting in undercharge of pixel units. In the event of undercharge of pixel units, on one hand, the transmittance of panels will be decreased, so that it is required to increase the backlight brightness to maintain the same brightness to be displayed and the cost of backlight modules will thus be increased; on the other hand, the display effect of low-grayscale pictures will be influenced by the undercharge, so that it is more likely to have mura phenomenon. An existing method for solving the problem of undercharge of pixels may be to prolong the enabling time of the gate by a specific scan driving method. Nevertheless, conventional scan driving circuits still lack a solution by which the cost can be effectively reduced and the quality can be improved, and which is suitable for both 2D display and 3D display.

Therefore, it is necessary to provide a scan driving method for a display panel to overcome the problems existing in the conventional technology.

### SUMMARY OF THE INVENTION

In view of the shortcomings of the conventional technology, a main objective of the present invention is to provide a scan driving method for a display panel, which can effectively reduce the cost and improve the quality, and which is suitable for both 2D display and 3D display.

In order to achieve the above-mentioned objective of the present invention, a scan driving method for a display panel is provided. The display panel has a pixel driving circuit including n scanning lines and m data lines; and the scanning lines and the data lines intersect each other to define a plurality of pixel units. The scan driving method includes the following step:

enabling the xth scanning line by a clock signal having a duty cycle not more than 45%, and meanwhile enabling the (x+2)th scanning line, where x is an positive integer and 1≦x≦n−2.

In one embodiment of the present invention, the odd numbered data lines are connected to the kth and (k+1)th rows of pixel units, where k=4n−3; and the even numbered data lines are connected to the jth and (j+1)th rows of pixel units, where j=4n−1.

In one embodiment of the present invention, among each four of the scanning lines, the first scanning line and the third scanning line are together connected to a clock signal input terminal; and the second scanning line and the fourth scanning line are connected to another clock signal input terminal.

In one embodiment of the present invention, the duty cycle of a clock signal outputted from the clock signal input terminals is 40% to 45%.

In one embodiment of the present invention, among each eight of the scanning lines, the scanning lines are connected to eight clock signal input terminals, respectively.

In one embodiment of the present invention, the duty cycle of a clock signal outputted from the clock signal input terminals is 25%.

In one embodiment of the present invention, the duty cycle of a clock signal outputted from the clock signal input terminals is 40% to 45%, and wherein the first to the fourth scanning lines are simultaneously enabled according to the same clock signal.

The present invention is mainly to have different signals written to adjacent pixel units in a vertical direction (i.e., the column direction) in the pixel driving circuit, by exchanging the timing sequence at which the third scanning line and the second scanning line in each group of four scanning lines receive a clock signal, and by ensuring the gates connected to the first scanning line and the third scanning line to be enabled simultaneously and the gates connected to the second scanning line and the fourth scanning line to be enabled simultaneously. In this way, the charging time of corresponding pixel units is doubled, and consequently, the quality of display is effectively improved.

### BRIEF DESCRIPTION OF THE DRAWINGS

FIG. 1 is a schematic diagram of a pixel driving circuit according to one embodiment of the present invention;

FIG. 2 is a flowchart of a scan driving method according to the present invention;

FIG. 3 is a timing sequence diagram of signal lines according to a first embodiment of the present invention;

FIG. 4 is a timing sequence diagram of signal lines according to a second embodiment of the present invention;

FIG. 5 is a timing sequence diagram of signal lines according to a third embodiment of the present invention; and

FIG. 6 is a timing sequence diagram of signal lines according to a fourth embodiment of the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side, etc., are only directions with reference to the accompanying drawings, so that the used directional terms are used to describe and understand the present invention, but the present invention is not limited thereto.

GOA (gate on array) technology, as a common method in the industry by which the manufacturing cost can be effectively reduced, is mainly to directly manufacture a scan driving circuit onto an array substrate, that is, to realize functions of a gate driving chip onto a glass substrate through the manufacturing process of TFT-LCD (thin-film transistor liquid crystal display), so that gate driving chips can be omitted. In the present invention, the driving circuit at the gate side is directly mounted on a TFT array substrate on the basis of a dual-data-line driving structure, and in this way, the traditional scan driving chip is omitted. In addition to the reduction of cost, this method can further facilitate the realization of a narrow-frame panel even a frameless panel, thereby increasing competitive advantages in the market of liquid crystal display products.

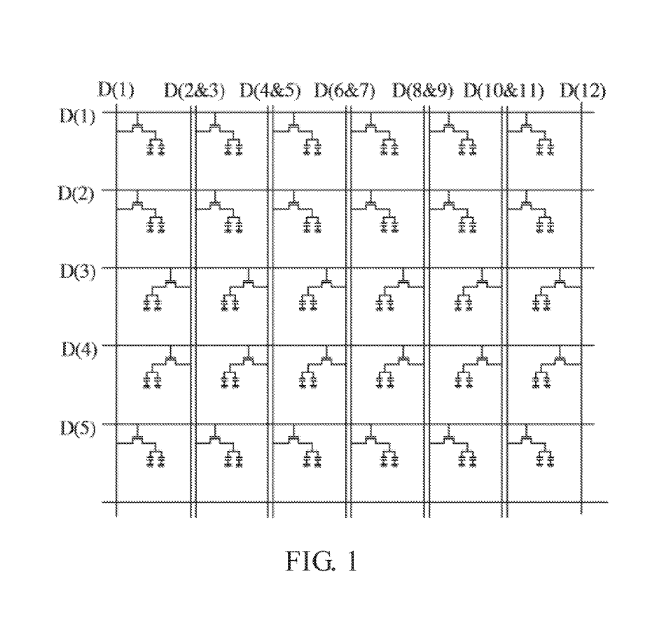

Referring to FIG. 1, a schematic diagram of a pixel driving circuit according to one embodiment of the present invention is shown. The pixel driving circuit is used for a liquid crystal display panel, including a plurality of scanning lines G1, G2, G3, . . . , Gn and a plurality of data lines D1, D2, D3, . . . , D2m, where n and m are positive integers. The scanning lines extend in a horizontal direction (the row direction), and are arranged in parallel along a vertical direction (the column direction). The data lines extend in the vertical direction and are arranged in parallel along the horizontal direction. The scanning lines and the data lines intersect each other to define a plurality of pixel units. The pixel driving circuit in this embodiment is a dual-data-line driving circuit, wherein the odd numbered data lines are connected to the kth and (k+1)th rows of pixel units, where k=4n−3, that is, the data lines D1, D3, D5, . . . , D2m−1 are connected to the pixel units on the 1st, 2nd, 5th, 6th, 9th, 10th . . . scanning lines; and the even numbered data lines are connected to the jth and (j+1)th rows of pixel units, where j=4n−1, that is, the data lines D2, D4, D6, . . . , D2m are connected to the pixel units on the 3rd, 4th, 7th, 8th, 11th, 12th . . . scanning lines.

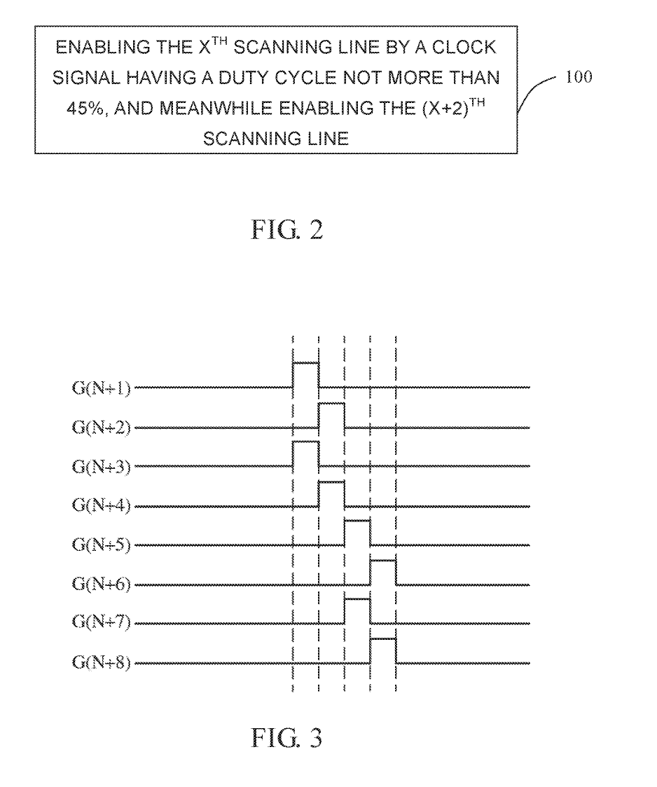

Referring to FIG. 2 and FIG. 3, a flowchart of a scan driving method according to the present invention is shown in FIG. 2; and a timing sequence diagram of signal lines according to a first embodiment of the present invention is shown in FIG. 3. With regard to the pixel driving circuit of FIG. 1, in order to ensure that there are different data written to adjacent pixel units in the vertical direction (i.e., the column direction) under the driving of 2D display, the scan driving method in this embodiment is to exchange the timing sequences of enabling the third scanning line and the second scanning line in each group of four scanning lines, and meanwhile enable the first scanning line and the third scanning line simultaneously, and enable the second scanning line and the fourth scanning line simultaneously. In this way, the charging time of the corresponding pixel units is doubled. The specific scan driving waveform is as shown in FIG. 2. That is, as shown in FIG. 2, the scan driving method of this embodiment includes the following step:

S100: enabling the (x+2)th scanning line simultaneously when the xth scanning line is enabled, where x is an integer and 1≦x≦n−2.

In order to realize the aforementioned driving method for the scanning lines, the pixel driving circuit of the present invention may be designed to have two clock signal input terminals, four clock signal input terminals or eight clock signal input terminals, and be preferably designed to output a clock signal having a duty cycle not more than 45%.

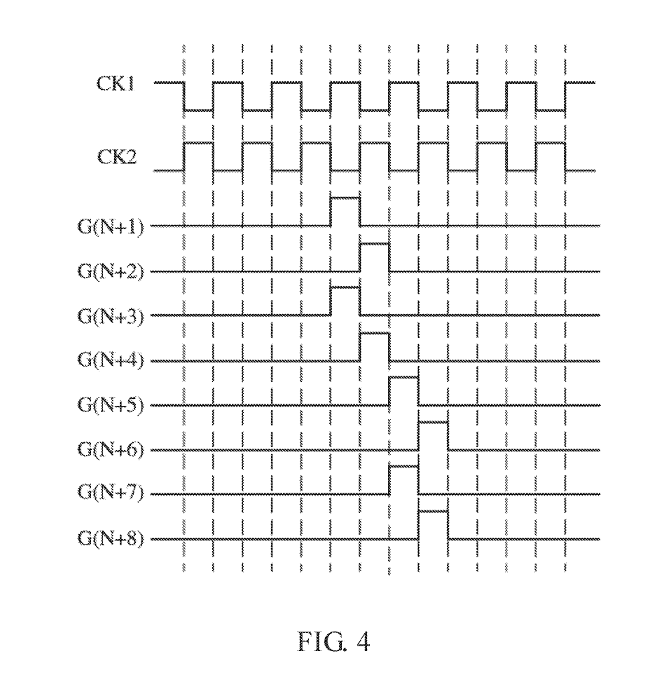

Referring to FIG. 4, taking the pixel driving circuit having two clock signal input terminals as an example, among each four of the scanning lines, the first scanning line and the third scanning line are together connected to a clock signal input terminal CK1; and the second scanning line and the fourth scanning line are connected to the other clock signal input terminal CK2. Therefore, a clock signal inputted from the clock signal input terminal CK1 can simultaneously enable scanning lines G(N+1) and G(N+3); and a clock signal inputted from the other clock signal input terminal CK2 can simultaneously enable scanning lines G(N+2) and G(N+4). In more detail, the scanning lines are enabled, upon receiving the clock signal, in the following sequence G(1&3)→G(2&4)→G(5&7)→G(6&8) . . . , and the rest may be deduced by analogy. In order to ensure the normal operation of the pixel driving circuit, the duty cycle of a clock signal outputted from the clock signal input terminals is preferably set as 40% to 45%.

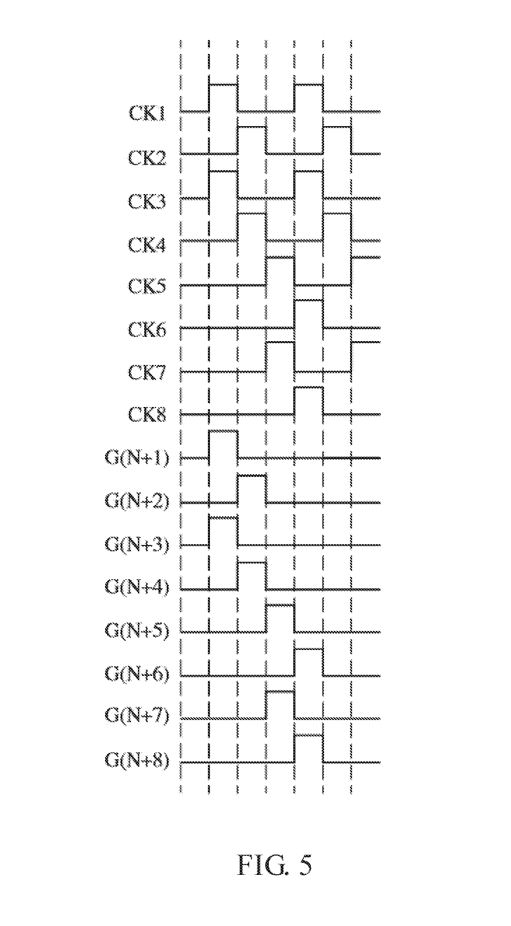

Referring to FIG. 5, taking the pixel driving circuit having eight clock signal input terminals as another example, among each eight of the scanning lines, the scanning lines are connected to the eight clock signal input terminals, respectively. That is, CK1, CK2, . . . , CK8 are respectively connected to G(N+1), G(N+2), . . . , G(N+8), and then the eight clock signal input terminals are controlled to output corresponding clock signals to simultaneously enable the scanning lines G(N+1) and G(N+3), G(N+2) and G(N+4), G(N+5) and G(N+7), G(N+6) and G(N+8). In more detail, the scanning lines are enabled, upon receiving the clock signals, in the following sequence: G1→G5→G9, G2→G6→G→10, G3→G7→G11, G4→G8→G12G . . . , and the rest may be deduced by analogy. In order to ensure the normal operation of the pixel driving circuit, the duty cycle of the clock signal is preferably set as 25%. For a large-size high-resolution panel, the longer the wiring is, the smaller the line width is. Consequently, the distortion of waveform during the transmission process becomes more serious due to RC delay. As a result, the waveform of the outputted gate signal is distorted, and thereby resulting in problems such as undercharge or wrong charging. In this embodiment, with eight clock signal inputs, the distortion of waveform due to the RC delay may be alleviated.

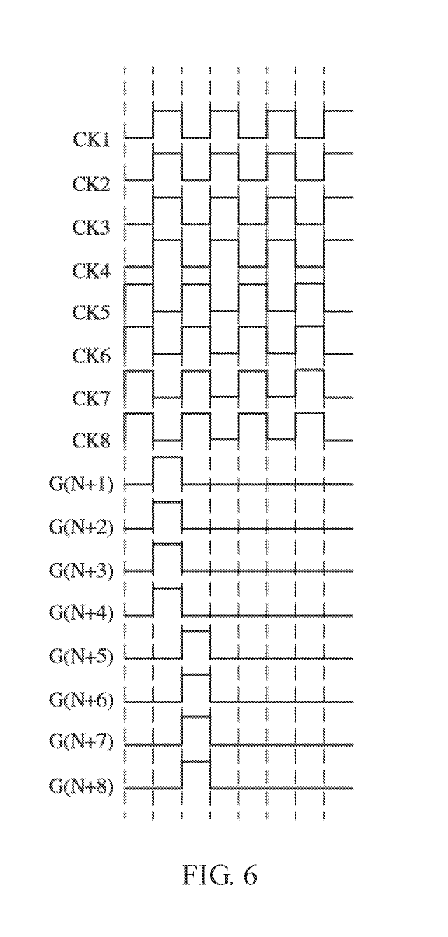

Referring to FIG. 6, in order to realize 3D driving, four scanning lines must be enabled simultaneously to maintain a constant bandwidth of the driving chip so as to ensure that the left eye and the right eye of a user receive a 60 HZ driving signal, respectively, to avoid perceiving flicker. Hence, in this case, the pixel driving circuit is required to be designed to have four clock signal input terminals or eight clock signal input terminals, wherein the duty cycle of the clock signal outputted from the clock signal input terminals is preferably set as 40% to 45%, and the first to fourth scanning lines are simultaneously enabled according to the same clock signal. The signal transmission process is the same as that for 2D driving as shown in FIG. 5.

In conclusion, the present invention is mainly to have different signals written to adjacent pixel units in a vertical direction (i.e., the column direction) in the pixel driving circuit, by exchanging the timing sequence at which the third scanning line and the second scanning line in each group of four scanning lines receive a clock signal, and by ensuring the gates connected to the first scanning line and the third scanning line to be enabled simultaneously and gates connected to the second scanning line and the fourth scanning line to be enabled simultaneously. In this way, the charging time of corresponding pixel units is doubled, and consequently, the quality of display is effectively improved.

The present invention has been described with preferred embodiments thereof, and it is understood that many changes and modifications to the described embodiment can be carried out without departing from the scope and the spirit of the invention that is intended to be limited only by the appended claims.

What is claimed is:

1. A scan driving method for a display panel, wherein the display panel comprises a pixel driving circuit comprising n scanning lines and m data lines; and the scanning lines and the data lines intersect each other to define a plurality of pixel units, and the scan driving method comprises the following step:
enabling the xth scanning line by a clock signal having a duty cycle not more than 45%, and meanwhile enabling the (x+2)th scanning line, where x is an positive integer and 1≦x≦n−2.

2. The scan driving method for the display panel as claimed in claim 1, wherein the odd numbered data lines are connected to the kth and (k+1)th rows of pixel units, where k=4n−3; and the even numbered data lines are connected to the jth and (j+1)th rows of pixel units, where j=4n−1.

3. The scan driving method for the display panel as claimed in claim 1, wherein among each four of the scanning lines, the first scanning line and the third scanning line are together connected to a clock signal input terminal; and the second scanning line and the fourth scanning line are connected to another clock signal input terminal.

4. The scan driving method for the display panel as claimed in claim 3, wherein the duty cycle of a clock signal outputted from the clock signal input terminals is 40% to 45%.

5. The scan driving method for the display panel as claimed in claim 1, wherein among each eight of the scanning lines, the scanning lines are connected to eight clock signal input terminals, respectively.

6. The scan driving method for the display panel as claimed in claim 5, wherein the duty cycle of a clock signal outputted from the clock signal input terminals is 25%.

7. The scan driving method for the display panel as claimed in claim 5, wherein the duty cycle of a clock signal outputted from the clock signal input terminals is 40% to 45%, and wherein the first to the fourth scanning lines are simultaneously enabled according to the same clock signal.

8. A scan driving method for a display panel, wherein the display panel comprises a pixel driving circuit comprising n scanning lines and m data lines; and the scanning lines and the data lines intersect each other to define a plurality of pixel units, wherein the odd numbered data lines are connected to the kth and (k+1)th rows of pixel units, where k=4n−3; and the even numbered data lines are connected to the jth and (j+1)th rows of pixel units, where j=4n−1; among each eight of the scanning lines, the scanning lines are connected to eight clock signal input terminals, respectively; the scan driving method comprises the following step:
enabling the xth scanning line by a clock signal having a duty cycle not more than 45%, and meanwhile enabling the (x+2)th scanning line, where x is an positive integer and 1≦x≦n−2.

9. The scan driving method for the display panel as claimed in claim 8, wherein the duty cycle of a clock signal outputted from the clock signal input terminals is 25%.

10. The scan driving method for the display panel as claimed in claim 8, wherein the duty cycle of a clock signal outputted from the clock signal input terminals is 40% to 45%, and wherein the first to the fourth scanning lines are simultaneously enabled according to the same clock signal.
